(19) United States
(12) Patent Application Publication
(10) Pub. No.: US 2005/0215756 A1
(43) Pub. Date: Sep. 29, 2005

(54) Basic polymer obtained by hydrogenation

(76) Inventors: Jochen Houben, Kempen (DE); Claudius Neumann, Rossdorf (DE); Richard Mertens, Krefeld (DE); Olaf Hoeller, Greensboro, NC (US)

Correspondence Address: SMITH MOORE LLP, P.O. BOX 21927, GREENSBORO, NC, 27420, US

(21) Appl. No.: 10/508,491

(22) PCT Filed: Mar. 20, 2003
(86) PCT No.: PCT/EP03/02935

§ 371 Date: Jun. 13, 2005

(30) Foreign Application Priority Data
Mar. 21, 2002 (DE) 102 12 702.6

(51) Int. Cl. C08G 69/08

(52) U.S. Cl. 528/310

(57) ABSTRACT

The present invention relates to processes for producing a basic polymer, wherein an amide polymer obtainable by chain polymerization and with at least one of the following properties: (a) a glass transition temperature in the range of from about 30 to about 250° C., (b) a molar mass of at least about 1,000 g/mol, (c) a viscosity as about 20% by weight aqueous solution of at least about 500 mPa×s, (d) uncrosslinked is hydrogenated.

This application is a national stage application under 35 U.S.C. 371 of international application no. PCT/EP03/02935 filed Mar. 20, 2003, which is based on German Application no. DE 102 12 702.6, filed on Mar. 21, 2002, and claims priority thereto.

### BACKGROUND OF THE INVENTION

The invention relates to a process for producing a basic polymer, to this polymer, to a process for producing a composition, to this composition, to production of a composite, to this composite, to foams, moldings, fibers, sheets, films, cables, sealing materials, liquid-absorbing sanitary articles, supports for plant and fungicidal growth-regulating means, packaging materials, construction materials and soil additives, comprising the basic polymer or the composition or the composite and to the use of the basic polymer or the composition or the composite in foams, moldings, fibers, sheets, films, cables, sealing materials, liquid-absorbing sanitary articles, supports for plant and fungicidal growth-regulating means, packaging materials, construction materials and soil additives as well as for flocculation in retention in paper production, for impurity fixing in paper production, for dry strength in paper production or for wet strength in paper production.

Polymers known as “mixed-bed ion-exchange absorbent polymers” (MBIEA polymers) are disclosed in WO99/34843 and are distinguished in that they may absorb large amounts of synthetic urine under load. MBIEA polymers usually have a composition that comprises basic absorbent polymers, which are capable of exchanging anions and an absorbent polymer, which is acidic in comparison to the basic absorbent polymer and is capable of exchanging cations. The basic absorbent polymer has basic groups and is typically obtained by polymerization of monomers, which carry basic groups, or groups, which may be converted into basic groups. These monomers are primarily those that comprise primary, secondary and/or tertiary amines and the corresponding phosphines. This group of monomers includes, in particular, allylamine, diallylamine, 4-aminobutene, vinyl formamide, 5-aminopentene and the like and the secondary or tertiary amine derivatives thereof.

MBIEA polymers are preferably used in articles intended for the absorption of bodily fluids. These are primarily diapers which are used for babies and incontinence in the elderly and ladies' sanitary articles which are used in conjunction with menstrual bleeding. Common to all applications of these articles is the fact that the articles are used in contact with the skin for a comparatively long time, in general several hours. As bodily fluids are absorbed by the articles they are also in fluid contact with the skin or mucous membranes over this long period.

Therefore, the toxicological demands, which are placed on the articles or the components of which the articles consist, are very high. The monomers used in the conventional process for producing basic absorbent polymers are, however, toxicologically questionable even in small amounts under these circumstances. Furthermore, these processes are expensive and limit the production capacities.

### BRIEF SUMMARY OF THE PRESENT INVENTION

Therefore, the object according to the present invention includes in overcoming the drawbacks of the prior art.

Furthermore, one object according to the present invention is to provide a MBIEA polymer composition with as low a residual monomer concentration as possible. In addition, one object according to the present invention is to provide a MBIEA polymer composition, which, in addition to the lowest possible residual monomer content, is capable of absorbing synthetic urine under load in large amounts.

Furthermore, one object according to the present invention includes in providing sanitary articles, which, owing to good toxicological properties, offer high comfort in wear with a low risk of skin or mucous membrane irritation.

An object of the present invention is also to provide a polymer, which is suitable for flocculation, for retention in paper production, for impurity fixing in paper production, for dry strength in paper production or for wet strength in paper production.

One object according to the present invention is also to provide a basic polymer, which has the lowest possible residual monomer content and may therefore be used in toxicologically sensitive applications, in particular in the sanitary sector, in soil or in water treatment.

### DETAILED DESCRIPTION OF THE PRESENT INVENTION

The above objects are achieved by a process for producing a basic polymer, wherein an amide polymer obtainable by chain polymerization (hereinafter called “amide polymer”) with at least one, preferably all, of the following properties:
(a) a glass transition temperature according to DIN-EN-ISO 11357 in the range of from about 30 to about 250° C., preferably of from about 100 to about 200° C. and particularly preferably of from about 165 to about 195° C.,
(b) a molar mass according to DIN 55672-3 of at least about 1,000 g/mol, preferably of from about 1,000 to about 1×10⁷ g/mol, particularly preferably of from about 10,000 to about 1×10⁵ g/mol and more particularly, preferably of from about 50,000 to about 500,000 g/mol,
(c) a viscosity according to ASTM-D 1824/90 at about 20° C. as about 20% by weight aqueous solution of at least about 500 mPa×s, preferably from about 500 to about 200,000 mPa×s, particularly preferably from about 500 to about 100,000 mPa×s and more particularly preferably from about 500 to about 5,000 mPa×s,
(d) uncrosslinked is hydrogenated.

The combination of properties of two or more of these properties resulting from the above-mentioned properties represent respectively preferred embodiments of the process according to the present invention. Processes in which the amide polymer exhibits the properties or combinations of properties illustrated hereinafter as letters or combinations of letters: a, b, c, d, ab, abc, abcd, bc, bcd, cd, wherein abcd, ab or abd is preferred and ab is particularly preferred, are also embodiments of the present invention which are particularly preferred.

According to the invention the term “amide polymer obtainable by chain polymerization” is taken to mean a polymer containing at least one amide group and which is obtained by chain polymerization of monomers containing at least one amide group. “Chain polymerization according to the invention” is taken to mean any polymerization process in which there is no elimination of a component, as is conventional in condensation polymerization. Preferred chain polymerization processes include free radical, anionic, cationic, group transfer, coordinative or ring opening polymerization, free radical polymerization being preferred. Preferred amide polymers according to the present invention are formed from acrylamide and optionally a comonomer which may be copolymerized with acrylamide. At least one comonomer in an amount in the range of from about 0.01 to about 90% by weight, preferably of from about 0.1 to about 70% by weight and particularly preferably of from about 1 to about 50% by weight, and more particularly preferably of from about 2 to about 30% by weight, based on the sum of monomers used, is polymerized in this acrylamide copolymer as comonomer.

Preferred comonomers are acrylic acid, methacrylic acid, methacrylic acid amide, di-methacrylic acid amide, methylmethacrylate, acrylonitrile, vinyl acetate, vinyl formamide, vinyl acetamide, N-isopropylacrylamide, N-isopropylmeth-acrylamide, aminopropylacrylamide, amino-2,2-dimethylpropylacrylamide, aminoethyla-crylamide, aminopropylacrylate, amino-2,2-dimethylpropylacrylate, aminoethylacrylate, aminopropylmethacrylamide, amino-2,2-dimethylpropylmeth-acrylamide, aminoethylmethacrylamide, N-methyl-aminopropylacrylamide, N-methyl-amino-2,2-dimethylpropylacrylamide, N-methyl-aminoethylacrylamide, N-methyl-aminopropylacrylate, N-methyl-amino-2,2-dimethylpropylacrylate, N-methyl-aminoethylacrylate, N-methyl-aminopropylmethacrylamide, N-methyl-amino-2,2-dimethylpropylmethacrylamide, N-methyl-aminoethylmethacrylamide, N-ethyl-aminopropylacrylamide, N-ethyl-amino-2,2-dimethylpropylacrylamide, N-ethyl-aminoethylacrylamide, N-ethyl-aminopropylacrylate, N-ethyl-amino-2,2-dimethylpropylacrylate, N-ethyl-aminoethylacrylate, N-ethyl-aminopropylmeth-acrylamide, N-ethyl-amino-2,2-dimethylpropylmethacrylamide, N-ethyl-amino-ethylmethacrylamide, N,N-dimethylaminopropylacrylamide, N,N-dimethylamino-2,2-dimethylpropylacrylamide, N,N-dimethylaminoethylacrylamide, N,N-dimethylaminopropylacrylate, N,N-dimethylamino-2,2-dimethylpropylacrylate, N,N-dimethylaminoethylacrylate, N,N-diethylaminopropylacrylamide, N,N-diethylamino-2,2-dimethylpropylacrylamide, N,N-diethylaminoethylacrylamide, N,N-diethylaminopropylacrylate, N,N-diethylamino-2,2-dimethylpropylacrylate, N,N-diethylaminoethyulacrylate, N,N-dimethylaminopropylmethacrylamide, N,N-dimethylamino-2,2-dimethylpropylmethacrylamide, N,N-dimethylaminoethylmeth-acrylamide, N,N-dimethylaminopropylmethacrylate, N,N-dimethylamino-2,2-dimethylpropylmethacrylate, N,N-dimethylaminoethylmethacrylate, N,N-diethylaminopropylmethacrylamide, N,N-diethylamino-2,2-dimethylpropyl-acrylamide, N,N-diethylaminoethylmethacrylamide, N,N-diethylaminopropyl-methacrylate, N,N-diethylamino-2,2-dimethylpropylmethacrylate, N,N-diethylaminoethylmethacrylate, acrylamidopropane sulphonic acids or the salts thereof wherein acrylonitrile, vinyl formamide, vinyl acetamide, N-isopropylacrylamide, N,N-dimethylaminopropylacrylamide, N,N-dimethyl-aminoethylacrylamide, N,N-dimethylaminoethylacrylate, N,N-diethylaminopropyl-acrylamide, N,N-dimethylaminopropylmethacrylamide, N,N-dimethylaminoethyl-methacrylate, methacrylic acid amide or dimethacrylic acid amide are preferred and vinyl formamide, vinyl acetamide, N,N-dimethylaminopropylacrylamide, N,N-dimethylaminoethylacrylamide, N,N-dimethylaminopropylmethacrylamide, methacrylic acid amide or dimethylacrylic acid amide are particularly preferred.

According to a preferred embodiment of the present invention the amide polymers preferably have a glass transition temperature of at most about 70° C. and are in the form of waxes. The amide polymers with a glass transition temperature of more than about 70° C., according to a different embodiment of the present invention, are designated solids.

According to the present invention, “uncrosslinked” is taken to mean that the polymer in question may be dissolved in a solvent without covalent chemical bonds between the chains of the polymer having to be broken up and owing to the dissolving process the molecular weight of the polymer to be dissolved is reduced. This may be determined, by way of example, by the filter test. The amide polymer is preferably present in uncrosslinked form if less than about 80% by weight, preferably less than about 40% by weight, and particularly preferably less than about 20% by weight and more particularly preferably less than about 10% by weight, of the polymer used in the filter test remains as residue on the residue determined via the filter test.

The amide polymer is preferably water-soluble, preferably no residue consisting of the amide polymer remaining in the filter test.

The amide polymer may be produced by polymerization processes known to the person skilled in the art. In this context, radical substance, suspension or emulsion polymerization is to be mentioned by way of example. Further details may be found in Odian “Principles of Polymer Chemistry”, 2nd Edition, Wiley Interscience 1981, page 296 with further proofs.

It is also preferred, according to the present invention that hydrogenation is carried out by means of a hydrogenating catalyst. The hydrogenating catalyst preferably comprises a, preferably catalytically active, element of groups VI B, VII B or VIII B of the periodic table of elements or at least two of them. Of these, ruthenium, rhodium, palladium, molybdenum, tungsten and rhenium are preferred, and ruthenium is particularly preferred.

Ruthenium is used according to the present invention preferably as a zero-valent metal and/or in the form of various inorganic, organic or complex compounds. Of these, ruthenium black, ruthenium powder, ruthenium oxide, ruthenium nitrate, nitrosilruthenium nitrate, ruthenium chloride, ruthenium bromide, ruthenium iodide, oxydecachlororuthenium acid ammonium, pentachloroaquaruthenium acid ammonium, oxydecachlorodiruthenium acid potassium, oxydecachlorodiruthenium acid sodium, pentachloroaquaruthenium acid potassium, perruthenium acid potassium, hexaamineruthenium chloride, pentaaminechlororuthenium chloride, hexaamineruthenium bromide, dodecacarbonyltriruthenium, hexacarbonyl-tetrachlorodiruthenium, tris(acetylacetonate)ruthenium, dichlorotricarbonyl-ruthenium dimers, dichlorotris(triphenylphosphine)ruthenium, dichlorodicarbonyl-bis(triphenylphosphine)ruthenium, dicarbonylcyclopentadienylruthenium dimers or bis(cyclopentadienyl)ruthenium are preferred.

The rhodium may be used in its zero-valent form or as an inorganic or organic or complex compound. Preferred rhodium compounds are rhodium black, rhodium powder, rhodium oxide, rhodium nitrate, rhodium acetate, rhodium acetate dimers, rhodium chloride, rhodium bromide, rhodium iodide, hexachlororhodium acid ammonium, pentachloroaquarhodium acid ammonium, pentachloroaquarhodium acid potassium, hexachlororhodium acid sodium, hexabromorhodium acid sodium, chloropentaaminerhodium chloride, dodecacarbonyltetrarhodium, hexadeca-carbonylhexarhodium, tris(acetylacetonate)rhodium, bis(1,3-diphenyl-1,3-propane dionate)rhodium acetate or bis(pentamethylcyclopentadienyl)-dichlororhodium.

According to the present invention palladium may be used once as a zero-valent metal and/or in the form of various inorganic, organic or complex compounds. Of these, palladium black, palladium powder, palladium oxide, palladium nitrate, palladium acetate, palladium sulphate, palladium chloride, palladium bromide, palladium ioide, hexachloropalladium acid ammonium, tetrachloropalladium acid ammonium, dinitrodiamine palladium, hexachloropalladium acid potassium, tetrabromopalladium acid potassium, hexachloropalladium acid sodium or bis(acetylacetonate)palladium are preferred.

Molybdenum may be used, according to the present invention, on the one hand in the form of zero-valent metal and/or as inorganic, organic or complex compounds. Of these, molybdenum hexacarbonyl, molybdenum acid ammonium, molybdenum acetate, molybdenum oxide or molybdenum oxide acetyl acetonate are preferred.

Tungsten may be used according to the present invention as zero-valent metal and/or in the form of its inorganic, organic or complex compounds. Of these, tungsten hexacarbonyl, tungsten oxide, tungstic acid or paratungstic acid ammonium are preferred.

According to the present invention rhenium may be used in the form of the zero-valent metal or as inorganic, organic or complex compounds. Of these, rhenium carbonyl, rhenium oxide, rhenium acid, rhenium acid ammonium, rhenium chloride or cyclopentadienylrhenium carbonyl are preferred.

In another embodiment of the process according to the present invention it is preferred if the hydrogenating catalyst comprises a support on which the elements of the groups VI B, VII B or VIII B of the periodic table of elements or the compounds thereof are applied. The element content of the hydrogenating catalyst with a support is from about 0.01 to about 70% by weight, preferably from about 0.1 to about 60% by weight and particularly preferably from about 0.5 to about 50% by weight, based on the hydrogenating catalyst with support.

The hydrogenating catalyst with support may be produced by generally known processes. Examples of possible processes are the dipping process, the ion-exchange process, physical mixing and others.

If production is by the dipping process, the metal compounds of the aforementioned groups of the periodic table of elements are dissolved in a suitable solvent, the support added and the mixture optionally allowed to rest for a certain time and then dried. A reduction may occur after drying, however it is equally possible to also perform the reduction after burning. A reduction in the reaction system is also possible. The reduction process is not limited; hydrogen may be used and reduced in the gaseous phase or else substances such as hydrazine may be used and reduced in the liquid phase. The reduction temperature is not limited as long as at least one metal compound of the above-mentioned groups of the periodic table is reduced or oxidised to the zero-valent metal. This usually occurs at temperatures in the range of from about 200 to about 700° C., preferably of from about 300 to about 600 and particularly preferably of from about 400 to about 500° C.

A porous material is preferably used as support in the hydrogenating catalyst of the process according to the invention. Metal oxides or combined oxides, layered clay compounds, activated carbon and the like may preferably be used. Of these, silica, aluminium oxide and activated carbon are preferred, activated carbon being particularly preferred. It is also preferred in the process according to the invention to use the catalytically active elements of the hydrogenating catalyst in an amount in the range of from about 0.01 to about 20% by weight, preferably of from about 0.05 to about 10% by weight and particularly preferably from about 0.1 to about 5% by weight, based on the dry amide polymer in each case.

It is also preferred in the process according to the present invention that hydrogenation is carried out according to one, preferably all, of the following parameters:
(h1) in a liquid or supercritical, preferably liquid, phase,
(h2) at a temperature of at least about 30° C., preferably in the range of from about 70 to about 200° C. and particularly preferably in the range of from about 100 to about 150° C.,
(h3) a gas pressure of at least about 1 bar, preferably at least about 10 bar and particularly preferably in the range of from about 50 to about 300 bar,
(h4) a hydrogenating gas/inert gas ratio in the range of from about 10:1 to about 1:10, preferably of from about 4:1 to about 1:4 and particularly preferably of from about 2:1 to about 1:2.

Preferred embodiments of the parameters to be adhered to in the process according to the invention during hydrogenation emerge from the following combinations of figures: h1, h2, h3, h4, h1h2, h1h2h3, h1h2h3h4, h2h3, h2h3h4 and h3h4, wherein h1, h1h2 and h1h2h3 is preferred and h1h2h3 is particularly preferred.

Solvents which form a homogeneous solvent with the amide polymer, are inert to the conditions of the hydrogenating reaction and do not react with the reaction product are preferred as liquid phases. Of these, ethers such as diethylether, dimethoxyether, tetrahydrofuran, dioxane; amines such as diethylamine, diisopropylamine or triethylamine; hydrocarbons such as pentane, hexane, heptane or cyclohexane; alcohols such as methanol, ethanol, n-propanol, isopropanol, n-butanol, isobutanol or tert.-butanol; or even water or mixtures of at least two of these are preferred.

It is also preferred in the process according to the invention that the basic polymer exhibits at least one, preferably all, of the following features:
(A) a glass transition temperature to DIN-EN-ISO 11357 in the range of from about −50 to about 200° C., preferably of from about −40 to about 100° C. and particularly preferably of from about −30 to about 70° C.,
(B) a melting temperature determined by a process described hereinafter, in the range of from about −30 to about 230° C. and preferably of from about −20 to about 130° C.,
(C) a molar mass to DIN 55672-3 of at least about 1,000 g/mol, preferably in the range of from about 1,000 to about 2,000,000 g/mol and particularly preferably of from about 10,000 to about 1,000,000 g/mol,
(D) a viscosity to ASTM-D 1824/90 at 20° C. as a 20% by weight aqueous solution of at least about 30 mPa×s, preferably in the range of from about 30 mPa×s to about 300,000 and particularly preferably of from about 70 to about 100,000 mPa×s,
(E) a degree of neutralization to ERT 470.1-99 in the range of from about 0.1 to about 100 mol %,
(F) a pH to ERT 470.1-99 in the range of from about 5 to about 14.

According to a preferred embodiment of the basic polymer which is particularly suitable as a flocculent or a component thereof, which may preferably be used in water treatment, the molar mass (C) is above about 1,000,000 g/mol and preferably in the range of from about 100,000 to about 2,000,000 g/mol or the degree of neutralization (E) is in the range of from about 30 to about 100 mol %, preferably from about 40 to about 90 mol %. Of these, the combination of (C) and (E) is preferred as the embodiment of the invention when the basic polymer is used in water treatment. The basic polymer of this embodiment is also suitable for impurity fixing and strengthening, preferably in paper production.

According to a further preferred embodiment of the basic polymer which is particularly suitable as an absorbent polymer or a component thereof which may preferably be used in sanitary articles, the molar mass (C) is in the range of from about 300,000 to about 1,000,000 g/mol or the degree of neutralization (E) is in the range of from 0 to about 50 mol %, preferably from 0 to about 10 mol %. Of these, the combination of (C) and (E) is preferred as the embodiment of the invention when the basic polymer is used in sanitary articles.

According to a further preferred embodiment of the basic polymer which is particularly suitable as impurity fixer or strengthener or a component thereof, which may preferably be used in paper production, the molar mass (C) is in the range below about 300,000 g/mol and preferably in the range of from about 30,000 to about 300,000 g/mol or the degree of neutralization (E) is in the range of from about 30 to about 100 mol %, preferably from about 40 to about 90 mol %. Of these, the combination of (C) and (E) is preferred as the embodiment of the invention when the basic polymer is used in impurity fixing.

The pH (F) of the basic polymer is also in a range of from about 8 to about 13, preferably of from about 9 to about 12.5 if the basic polymer is used as a composition or to produce an absorbent composition, preferably for the production of sanitary articles.

In addition it is preferred in a further embodiment of the present invention that the pH (F) is in the range of from about 5 to about 9, preferably of from about 6 to about 8, if the basic polymer is used as auxiliary agent, preferably as a flocculent, in water treatment and conditioning.

The combinations of properties resulting from the above properties of two or more of these properties provide respectively preferred embodiments of the process according to the invention. Also particularly preferred as embodiments of the invention are processes in which the basic polymer exhibits the properties or combinations of properties shown hereinafter as letters or combinations of letters: A, B, C, D, E, F, AB, ABC, ABCD, ABCDE, ABCDEF, BC, BCD, BCDE, BCDEF, CD, CDE, CDEF, CEF, DE, DEF, EF, wherein CEF, DEF or CDEF is preferred and CDEF is particularly preferred.

The present invention also relates to a basic polymer which may be obtained from the processes according to the invention described above.

In addition, the invention relates to a process in which in further steps:
the basic polymer is optionally neutralized using a Bronsted acid,
the basic polymer is optionally crosslinked using a crosslinking agent,
the basic polymer is brought into contact with a polymer which is acidic in comparison with the basic polymer,
   whereby a composition (ZM) is obtained.

It is preferred for use of the composition (ZM) as absorbent for water that at least the basic or the acidic polymer, preferably both, are crosslinked. It is also preferred if the basic and the acidic polymer are mixed in ratios so the resulting composition (ZM) has a pH in a 0.9% by weight aqueous NaCl solution in the range of from about 4 to about 7, preferably from about 5 to about 6. In this connection, mixing ratios of basic to acidic polymer of from about 1:10 to about 10:1, preferably from about 1:2 to about 2:1 are preferred. This serves, in particular, for an acceptable comfort in wear of the sanitary article comprising the composition and for its dermatological acceptability.

It is preferred for the basic polymer to be neutralized to at least about 10 and, particularly preferably, at least about 50 mol %, based on the basic groups of the basic polymer, with a Bronsted acid. Bronsted acids such as H₂SO₄, H₃PO₄, HCl, glycolic acid, malonic acid or succinic acid are preferred for neutralization. These acids are preferably used to adjust the degree of neutralization.

Furthermore, the above-mentioned basic polymer or the neutralized polymer or the mixture thereof may be crosslinked, so a crosslinked basic or a crosslinked neutralized polymer is obtained. Any compounds capable of reacting with NH groups, NH₂ groups or mixtures thereof may be used as crosslinking agents for the basic polymers. Diepoxides are preferred, in particular 1,2:3,4-diepoxybutanes; dihalides, in particular α,ω-alkylene dihalides, preferably ethylene dibromide, propylene dichloride, butane-1,4-diiodide; diisocyanates, in particular 2,4-toluenediisocyanate and hexamethylene diisocyanate, dialdehydes, preferably glutaric aldehyde; diesters, diacylchlorides or dianhydrides of dicarboxylic acids, in particular oxalic acid, succinic acid, hexane dicarboxylic acid, maleic acid; disulphonyl chlorides, preferably aromatic disulphonyl chlorides, preferably benzenedisulphonyl chloride or compounds with a double bond suitable for Michael addition, preferably divinyl sulphone, maleic acid monoester, as also described as Class III crosslinking agents in this text.

For use of the composition (ZM) as absorbent for water, it is preferred that at least the basic or the acidic polymer, preferably both, are crosslinked. It is preferred if the basic and the acidic polymer are mixed in a ratio such that 1 g of the resulting composition (ZM) in one litre of a about 0.9% by weight NaCl solution has a pH in the range of from about 4 to about 7, preferably of from about 5 to about 6. In this connection, mixing ratios of basic to acidic polymer of from about 1:10 to about 10:1, preferably of from about 1:2 to about 2:1, are preferred. It is also preferred for both the basic polymer and the polymer which is acidic in comparison with the basic polymer to be used as particles which have a mean particle size to ERT 420-1-99 in the range of from about 10 to about 2,0001 μm preferably from about 100 to about 1,500 μm and particularly preferably from about 150 to about 850 μm. The components are brought into contact preferably by mixing the basic polymer with the acidic polymer, wherein it is preferred that a homogeneous mixture of basic and acidic polymer is produced. The mixing conditions are preferably selected such that the particles consisting of basic and acidic polymer are damaged to the least possible extent and consequently the formation of dust is largely avoided.

The present invention also relates to a composition which may be obtained from the above process. In addition, the present invention relates to a composition which comprises the above-described basic polymer and a polymer which is acidic in comparison with the basic polymer.

According to one embodiment of the present invention the acidic polymer is based on:
(α1) from about 0.1 to about 99.999% by weight, preferably from about 20 to about 98.99% by weight and particularly preferably from about 30 to about 98.95% by weight of polymerized, ethylenically unsaturated, acid group-containing monomers or salts thereof, wherein acrylic acid is preferred,
(α2) from 0 to about 70% by weight, preferably from about 1 to about 60% by weight and particularly preferably from about 1 to about 40% by weight of polymerized, ethylenically unsaturated monomers which may be copolymerized with (α1),
(α3) from about 0.001 to about 10% by weight, preferably from about 0.01 to about 7% by weight and particularly preferably from about 0.05 to about 5% by weight of one or more crosslinking agents,
(α4) from 0 to about 20% by weight, preferably from about 0.01 to about 7% by weight and particularly preferably from about 0.05 to about 5% by weight of one or more auxiliary agents, the sum of the amounts by weight (α1) to (α4) being about 100% by weight.

The monoethylenically unsaturated, acid group-containing monomers (α1) may be partially or completely, preferably partially, neutralized. The monoethylenically unsaturated, acid group-containing monomers are preferably neutralized to at most about 25 mol %, particularly preferably to at most about 20 mol % and most particularly preferably to at most about 10 mol %. The monomers (α1) may be neutralized before or after polymerization. The monomers may also be neutralized using alkali metal hydroxides, alkaline-earth metal hydroxides, ammonia and carbonates and bicarbonates. In addition, any further base is conceivable which forms a water-soluble salt with the acid. Mixed neutralization with various bases is also conceivable. Neutralization with ammonia or with alkali metal hydroxides is preferred, and it is particularly preferred with sodium hydroxide or ammonia.

Preferred monoethylenically unsaturated, acid group-containing monomers (α1) are acrylic acid, methacrylic acid, ethacrylic acid, α-chloroacrylic acid, α-cyanoacrylic acid, β-methylacrylic acid (crotonic acid), α-phenylacrylic acid, β-acryloxypropionic acid, sorbic acid, α-chlorosorbic acid, 2′-methylisocrotonic acid, cinnamic acid, p-chlorocinnamic acid, itaconic acid, citraconic acid, mesaconic acid, aconitic acid, maleic acid, fumaric acid, tricarboxyethylene and maleic acid anhydride, acrylic acid and methacrylic acid being particularly preferred and acrylic acid being most particularly preferred.

In addition to these carboxylate group-containing monomers, ethylenically unsaturated sulphonic acid monomers or ethylenically unsaturated phosphonic acid monomers are also preferred as monoethylenically unsaturated, acid group-containing monomers (α1).

Allylsulphonic acid or aliphatic or aromatic vinyl sulphonic acids or acrylic or methacrylic sulphonic acids are preferred as ethylenically unsaturated sulphonic acid monomers. Vinyl sulphonic acid, 4-vinylbenzyl sulphonic acid, vinyl toluene sulphonic acid and styrene sulphonic acid are preferred as aliphatic or aromatic vinyl sulphonic acids. Sulphoethyl(meth)acrylate, sulphopropyl(meth)acrylate and 2-hydroxy-3-methacryloxypropylsulphonic acids are preferred as acrylic and methacrylic sulphonic acids. 2-acryl-amido-2-methylpropane sulphonic acid is preferred as (meth)acrylaminoalkyl sulphonic acid.

Ethylenically unsaturated phosphonic acid monomers, such as vinyl phosphonic acid, allylphosphonic acid, vinyl benzyl phosphonic aid, (meth)acryl-amidoalkylphosphonic acids, acrylamidoalkyldiphosphonic acids, phosphono-methylated vinyl amines and (meth)acrylphosphonic acid derivatives are also preferred.

It is preferred according to the invention for the polymer to consist to at least about 50% by weight, preferably to at least about 70% by weight and most preferably to at least about 90% by weight, of carboxyl group-containing monomers. It is particularly preferred according to the invention for the polymer to consist to at least about 50% by weight, preferably to at least about 70% by weight, of acrylic acid which preferably is neutralized to at most about 50 mol %, particularly preferably to at most about 20 mol %.

Acrylamides and methacrylamides are preferred as monoethylenically unsaturated monomers (α2) which may be copolymerized with (α1). Possible (meth)acrylamides are, in addition to acrylamide and methacrylamide, alkyl-substituted (meth)acrylamides or aminoalkyl-substituted derivates of (meth)acrylamide, such as N-methylol(meth)acrylamide, N,N-dimethylamino(meth)acrylamide, dimethyl(meth)acrylamide or diethyl(meth)-acrylamide. Possible vinyl amides are, for example, N-vinyl amides, N-vinyl formamides, N-vinyl acetamides, N-vinyl-N-methylacetamides, N-vinyl-N-methylformamides, vinylpyrrolidone. Of these monomers, acrylamide is particularly preferred.

Water-dispersible monomers are also preferred as monoethylenically unsaturated monomers (α2) which may be copolymerized with (α1). Preferred water-dispersible monomers are acrylic esters and methacrylic esters, such as methyl(meth)acrylate, ethyl(meth)acrylate, propyl(meth)acrylate or butyl(meth)acrylate and vinyl acetate, styrene and isobutylene.

Preferred crosslinking agents (α3) according to the present invention are compounds which comprise at least two ethylenically unsaturated groups within one molecule (Class I crosslinking agents), compounds which comprise at least two functional groups which may react with functional groups of monomers (α1) or (α2) in a condensation reaction (=condensation crosslinking agent), in an addition reaction or in a ring opening reaction (Class II crosslinking agents), compounds which comprise at least one ethylenically unsaturated group and at least one functional group which may react with functional groups of monomers (α1) or (α2) in a condensation reaction, in an addition reaction or in a ring opening reaction (Class III crosslinking agents), or polyvalent metal cations (Class IV crosslinking agents). In the process, owing to the compounds of Class I crosslinking agents, crosslinking of the polymers is achieved owing to the free radical polymerization of the ethylenically unsaturated groups of the crosslinking agent molecule with the monoethylenically unsaturated monomers (α1) or (α2), while with the compounds of Class II crosslinking agents and the polyvalent metal cations of Class IV crosslinking agents, crosslinking of the polymers is achieved owing to condensation reaction of the functional groups (Class II crosslinking agents) or owing to electrostatic interaction of the polyvalent metal cation (Class IV crosslinking agents) with the functional groups of monomers (α1) or (α2). With the compounds of Class III crosslinking agents, there is accordingly crosslinking of the polymer both by free radical polymerization of the ethylenically unsaturated group and by condensation reaction between the functional group of the crosslinking agent and the functional groups of monomers (α1) or (α2).

Preferred compounds of Class I crosslinking agents are poly(meth)acrylic esters, which, for example, are obtained by reacting a polyol, such as ethylene glycol, propylene glycol, trimethylolpropane, 1,6-hexanediol, glycerol, pentaerythritol, polyethylene glycol or polypropylene glycol, an amino alcohol, a polyalkylenepolyamine, such as diethylenetriamine or triethylenetetraamine or an alkoxylated polyol with acrylic acid or methacrylic acid, preferably the acid halides thereof. Polyvinyl compounds, poly(meth)allyl compounds, (meth)acrylates of a monovinyl compound or (meth)acrylates of a mono(meth)allyl compound, preferably the mono(meth)allyl compounds of a polyol or of an amino alkyl, are also preferred as compounds of Class I crosslinking agents. Reference is made in this connection to DE 195 43 366 and DE 195 43 368.

Examples of compounds of Class I crosslinking agents include alkenyldi(meth)acrylates, for example ethylene glycoldi(meth)acrylate, 1,3-propylene glycoldi(meth)-acrylate, 1,4-butyleneglycoldi(meth)acrylate, 1,3-butylene-glycoldi(meth)acrylate, 1,6-hexanedioldi(meth)acrylate, 1,10-decanedioldi(meth)acrylate, 1,12-dodecanedioldi(meth)acrylate, 1,18-octadecanedioldi(meth)acrylate, cyclopentanedioldi(meth)acrylate, neopentyl-glycoldi(meth)acrylate, or pentaerythritoldi(meth)acrylate, alkenyldi(meth)-acrylamides, for example N-methyldi(meth)acrylamide, N,N′-3-methylbutylidene bis(meth)acrylamide, N,N′-(1,2-di-hydroxyethylene)-bis(meth)acrylamide, N,N′-hexamethylenebis(meth)acrylamide or N,N′-methylenebis(meth)acrylamide, polyalkoxydi(meth)acrylates, for example diethylene glycoldi(meth)acrylate, triethylene glycoldi(meth)acrylate, tetraethylene glycoldi(meth)acrylate, dipropylene glycoldi(meth)acrylate, tripropylene glycoldi(meth)acrylate or tetrapropylene glycoldi(meth)acrylate, bisphenol-A-di(meth)acrylate, ethoxylated bisphenol-A-di(meth)acrylate, benzylidine(meth)acrylate, 1,3-di(meth)acryloyloxy-propanol-2, hydroquinonedi(meth)acrylate, di(meth)acrylate ester of the preferably ethoxylated trimethylolpropane, preferably hydroxyalkylated with 1 to 30 mol alkylene oxide per hydroxyl group, thioethylene glycoldi(meth)acrylate, thiopropylene glycoldi(meth)acrylate, thiopolyethylene glycoldi(meth)acrylate, thiopolypropylene glycoldi(meth)acrylate, divinyl ether, for example 1,4-butanedioldivinyl ether, divinyl ester, for example divinyl adipate, alkanedienes, for example butadiene or 1,6-hexadiene, divinyl benzene, di(meth)allyl compounds, for example di(meth)allylphthalate or di(meth)allylsuccinate, diethyl(meth)allylamino-methyl(meth)acrylate ammonium chloride, vinyl(meth)acrylic compounds, for example vinyl(meth)acrylate, (meth)allyl(meth)acrylic compounds, for example (meth)allyl(meth)acrylate, (meth)allyl(meth)acrylate ethoxylated with 1 to 30 mol ethylene oxide per hydroxyl group, di(meth)allyl esters of polycarboxylic acids, for example di(meth)allylmaleate, di(meth)allylfumarate, di(meth)allylsuccinate or di(meth)-allylterephthalate, compounds with 3 or more ethylenically unsaturated, radically polymerisable groups, such as glyceroltri(meth)acrylate, (meth)acrylate ester of the glycerol hydroxyethylated with preferably 1 to 30 mol ethylene oxide per hydroxyl group, trimethylolpropane tri(meth)acrylate, tri(meth)acrylate ester of the preferably ethoxylated trimethylolpropane, preferably hydroxyalkylated with 1 to 30 mol alkylene oxide per hydroxyl group, (meth)allylidene di(meth)acrylate, 3-allyloxy-1,2-propane dioldi(meth)acrylate, tri(meth)allylcyanurate, tri(meth)allylisocyanurate, pentaerythritoltetra(meth)acrylate, pentaerythritol-tri(meth)acrylate, (meth)acrylic esters of pentaerythritol hydroxyethylated with preferably 1 to 30 mol ethylene oxide per hydroxyl group, tris(2-hydroxyethyl)isocyanuratetri(meth)acrylate, trivinyl trimellitate, tri(meth)allylamine, tri(meth)allylphosphate, tetra(meth)allylethylenediamine, poly(meth)allylester, tetra(meth)allyloxyethane or tetra(meth)allylammonium halides.

Preferred compounds of Class II crosslinking agents comprise at least two functional groups which may react with the functional groups of monomers (α1) or (α2), preferably with acid groups of monomers (α1) in a condensation reaction (=condensation crosslinking agent), in an addition reaction or in a ring opening reaction. These functional groups of the compounds of Class II crosslinking agents are preferably alcohol, amine, aldehyde, glycidyl, isocyanate, carbonate or epichloro functions.

Examples of compounds of Class II crosslinking agents include polyols, for example ethylene glycol, polyethylene glycols such as diethylene glycol, triethylene glycol and tetraethylene glycol, propylene glycol, polypropylene glycols such as dipropylene glycol, tripropylene glycol or tetrapropylene glycol, 1,3-butanediol, 1,4-butanediol, 1,5-pentanediol, 2,4-pentanediol, 1,6-hexanediol, 2,5-hexanediol, glycerol, polyglycerol, trimethylolpropane, polyoxypropylene, oxyethylene, oxypropylene block copolymers, sorbitan fatty acid esters, polyoxyethylene sorbitan fatty acid esters, pentaerythritol, polyvinyl alcohol and sorbitol, amino alcohols, for example ethanolamine, diethanolamine, triethanolamine or propanolamine, polyamine compounds, for example ethylenediamine, diethylenetriamine, triethylenetetraamine, tetraethylenepentaamine or pentaethylenehexaamine, polyglycidylether compounds such as ethylene glycoldiglycidylether, polyethylene glycoldiglycidylether, glyceroldiglycidylether, glycerolpolyglycidylether, penta-erythritolpolyglycidylether, propylene glycoldiglycidylether, polypropylene glycol-diglycidylether, neopentylglycoldiglycidylether, hexanediolglycidylether, trimethylolpropane polyglycidylether, sorbitolpolyglycidylether, phthalic acid diglycidyl ester, adipinic acid diglycidyl ether, 1,4-phenylene-bis(2-oxazolin), glycidol, polyisocyanates, preferably diisocyanates such as 2,4-toluene diisocyanate and hexamethylene diisocyanate, polyaziridine compounds such as 2,2-bis-hydroxymethylbutanol-tris[3-(1-aziridinyl)propionate], 1,6-hexamethylene di-ethylene urea and diphenylmethane-bis-4,4′-N,N′-diethylene urea, halogen epoxides, for example epichloro- and epibromohydrin and α-methylepichlorohydrin, alkylene carbonate such as 1,3-dioxolan-2-one (ethylene carbonate), 4-methyl-1,3-dioxolan-2-one (propylene carbonate), 4,5-dimethyl-1,3-dioxolan-2-one, 4,4-dimethyl-1,3-dioxolan-2-one, 4-ethyl-1,3-dioxolan-2-one, 4-hydroxymethyl-1,3-dioxolan-2-one, 1,3-dioxan-2-one, 4-methyl-1,3-dioxan-2-one, 4,6-dimethyl-1,3-dioxan-2-one, 1,3-dioxolan-2-one, poly-1,3-dioxolan-2-one, polyquarternary amines such as condensation products of dimethylamines and epichlorohydrin. Polyoxazolines such as 1,2-ethylene bisoxazoline, crosslinking agents with silane groups such as γ-glycidoxypropyltrimethoxysilane and γ-aminopropyltrimethoxysilane, oxazolidi-nones such as 2-oxazolidinone, bis- and poly-2-oxazolidinones and diglycol silicates are also preferred as compounds of Class II crosslinking agents.

Hydroxyl- or amino-group-containing esters of (meth)acrylic acid, such as 2-hydroxyethyl(meth)acrylate, and hydroxyl- or amino-group-containing (meth)acrylamides or mono(meth)allyl compounds of diols are preferred as compounds of Class III crosslinking agents.

The polyvalent metal cations of Class IV crosslinking agents are preferably derived from polyvalent cations. Preferred divalent cations are derived from zinc, beryllium, alkaline-earth metals, such as magnesium, calcium and strontium, magnesium being preferred. Further higher valent cations which may be used according to the invention are cations of aluminium, iron, chromium, manganese, titanium, zirconium and other transition metals and double salts of such cations or mixtures of said salts. Aluminium salts and alums and the various hydrates thereof, such as AlCl₃×6H₂O, NaAl(SO₄)₂×12H₂O, KAI(SO₄)₂×12H₂O or Al₂(SO₄)₃×14-18H₂O are preferably used.

Al₂(SO₄)₃ and its hydrates are particularly preferably used as crosslinking agent of the Class IV crosslinking agents.

Preferred polymers are polymers which are crosslinked by crosslinking agents of the following crosslinking agent classes or by crosslinking agents of the following combinations of crosslinking agent classes: I, II, III, IV, I II, I III, I IV, II III, I II IV, I III IV, II III IV, II IV or III IV. The above combinations of crosslinking agent classes each represent a preferred embodiment of crosslinking agents of a polymer.

Further preferred embodiments of the polymers are polymers which are crosslinked by any of the above-mentioned crosslinking agents of the Class I crosslinking agents. Of these, water-soluble crosslinking agents are preferred. In this connection, N,N′-methylene bisacrylamide, polyethylenglycoldi(meth)acrylates, triallylmethyl-ammonium chloride, tetraallylammonium chloride and allyl nonaethylene glycol acrylate produced with 9 mol ethylene oxide per mol acrylic acid are particularly preferred.

It is also preferred in one embodiment of the invention that, after the first crosslinking, generally occurring during polymerization, the acidic polymer is crosslinked once again by “post-crosslinking agents”. The compounds of Class II and IV crosslinking agents mentioned in connection with the crosslinking agents (α3) are preferred as post-crosslinking agents.

It is also preferred if the basic polymer is post-crosslinked by the crosslinking agents described above as suitable for the basic polymer. Here, in contrast to the first crosslinking, crosslinking of the surface region is preferred.

Of these compounds, diethylene glycol, triethylene glycol, polyethylene glycol, glycerol, polyglycerol, propylene glycol, diethanolamine, triethanolamine, polyoxypropylene, oxyethylene, oxypropylene block copolymers, sorbitan fatty acid esters, polyoxyethylene sorbitan fatty acid esters, trimethylolpropane, pentaerythritol, polyvinyl alcohol, sorbitol, 1,3-dioxolan-2-one (ethylene carbonate), 4-methyl-1,3-dioxolan-2-one (propylene carbonate), 4,5-dimethyl-1,3-dioxolan-2-one, 4,4-dimethyl-1,3-dioxolan-2-one, 4-ethyl-1,3-dioxolan-2-one, 4-hydroxymethyl-1,3-dioxolan-2-one, 1,3-dioxan-2-one, 4-methyl-1,3-dioxan-2-one, 4,6-dimethyl-1,3-dioxan-2-one, 1,3-dioxolan-2-one, poly-1,3-dioxolan-2-one are particularly preferred as post-crosslinking agents. Ethylene carbonate is particularly preferably used as post-crosslinking agent.

Preferred embodiments of the acidic polymers are those which are post-crosslinked by crosslinking agents of the following cross-linking agent classes or by crosslinking agents of the following combinations of crosslinking agent classes: II, IV and II IV. Further preferred embodiments of the acidic polymers are those which are post-crosslinked by any of the crosslinking agents mentioned above in crosslinking agent classes II or IV.

Preferably diluents, odour binders, surface-active agents or antioxidants are used as auxiliary agents (α4).

The acidic polymer or the amide polymer may be produced from the above-mentioned monomers and crosslinking agents by various polymerization processes. Examples in this connection include mass polymerization which preferably is carried out in kneading reactors such as extruders or by ribbon polymerization, solution polymerization, spray polymerization, inverse emulsion polymerization and inverse suspension polymerization. Solution polymerization is preferably carried out in water as the solvent. Solution polymerization may be performed continuously or discontinuously. A broad range of possible variations of reaction conditions such as temperature, type and amount of the initiators and the reaction solution may be found in the prior art. Typical processes are described in the following patents: U.S. Pat. No. 4,286,082, DE 27 06 135, U.S. Pat. No. 4,076,663, DE 35 03 458, DE 40 20 780, DE 42 44 548, DE 43 23 001, DE 43 33 056, DE 44 18 818.

The acidic polymers or the amide polymers are preferably synthesised by free radical polymerization which is started by polymerization initiators. Polymerization initiators may be contained in dissolved or dispersed form in a solution of monomers according to the invention. Any compounds decomposing into radicals and known to the person skilled in the art are suitable as initiators. These include, in particular, peroxides, hydroperoxides, hydrogen peroxide, persulphates, azo compounds and the so-called redox catalysts. The use of water-soluble catalysts is preferred. In some cases it is advantageous to use mixtures of various polymerization initiators. Of these mixtures, those consisting of hydrogen peroxide and sodium or potassium peroxodisulphate are preferred which may be used in any conceivable ratio. Suitable organic peroxides are, for example, acetyl acetone peroxide, methylethyl ketone peroxide, t-butylhydroperoxide, cumene hydroperoxide, t-amylperpivalate, t-butylperpivalate, t-butylperneohexonate, t-butylisobutyrate, t-butylper-2-ethylhexenoate, t-butylperisononanoate, t-butylpermaleate, t-butylperbenzoate, t-butyl-3,5,5-tri-methylhexanoate and amylpemeodecanoate. Azo compounds, such as 2,2′-azobis-(2-amidinopropane)dihydrochloride, 2,2′-azobis-(N,N-dimethylene)-isobutyramidine dihydrochloride, 2-(carbamoylazo)isobutyronitrile and 4,4′-azobis-(4-cyanovaleriac acid) are also preferred as polymerization initiators. Said compounds are used in conventional amounts, preferably in a range of from about 0.01 to about 5 mol %, preferably of from about 0.1 to about 2 mol %, based in each case on the amount of monomers to be polymerized.

The redox catalysts contain at least one of the above-stated per compounds as oxidic component and preferably ascorbic acid, glucose, sorbose, mannose, ammonium or alkali metal hydrogen sulphite, thiosulphate, hyposulphite or sulphide, metal salts such as iron-II-ions or silver ions or sodium hydroxymethyl sulphoxylate as reducing component. Ascorbic acid or sodium pyrosulphite is preferably used as reducing component of the redox catalyst. Based on the quantity of monomers used during polymerization, from about 1×10⁻⁵ to about 1 mol % of the reducing component of the redox catalyst and from about 1×10⁻⁵ to about 5 mol % of the oxidizing components of the redox catalyst are used. Instead of the oxidizing components of the redox catalyst, or in addition thereto, one or more, preferably water-soluble, azo compounds may be used.

According to the invention a redox system consisting of hydrogen peroxide, sodium peroxodisulphate and ascorbic acid is used. Generally, azo compounds are preferred according to the invention as initiators, wherein azo-bis-amidinopropane dihydrochloride is particularly preferred. Generally, polymerization is initiated with the initiators in a temperature range from 0 to about 90° C., preferably from 0 to about 20° C.

In addition it is preferred if the acid crosslinked polymer comprises at least one, preferably all of the following properties:
(s1) a free swell capacity to ERT 440.1-99 in the range of from about 1 to 30 g/g, preferably of from about 1.2 to about 10 g/g;
(s2) a pH in a about 1% aqueous solution in the range of from about 2 to about 6, preferably of from about 2 to about 4.

A preferred composition (ZM) according to the invention also exhibits at least one, preferably all, of the following properties:
(a) absorption under load at a pressure of about 0.9 psi according to the process disclosed in EP 339 461 A1 (AUL 0.9 psi) in the range of from about 10 to about 30 g/g, preferably of from about 15 to about 28 g/g and particularly preferably of from about 18 to about 25 g/g,
(b) absorption under load at a pressure of about 1.5 psi according to the process disclosed in EP 339 461 A1 (AUL 1.5 psi) in the range of from about 10 to about 28 g/g, preferably of from about 13 to about 25 g/g and particularly preferably of from about 15 to about 22 g/g,
(c) absorption against pressure at a pressure of about 0.3 psi over 1 hr to ERT 442.1-99 (AAP 0.3 psi/1 hr) in the range of from about 20 to about SOg/g, preferably of from about 25 to about 40 g/g and particularly preferably of from about 26 to about 35 g/g,
(d) absorption against pressure at a pressure of about 0.3 psi over 4 hr to ERT 442.1-99 (AAP 0.3 psi/4 hr) in the range of from about 25 to about 50 g/g, preferably of from about 27 to about 45 g/g and particularly preferably of from about 29 to about 42 g/g,
(e) absorption against pressure at a pressure of about 0.7 psi over 1 hr to ERT 442.1-99 (AAP 0.7 psi/1 hr) in the range of from about 14 to about 40 g/g, preferably of from about 16 to about 38 g/g and particularly preferably of from about 18 to about 35 g/g,
(f) absorption against pressure at a pressure of about 0.7 psi over 4 hr to ERT 442.1-99 (AAP 0.7 psi/4 hr) in the range of from about 15 to about 45 g/g, preferably of from about 17 to about 42 g/g and particularly preferably of from about 23 to about 40 g/g,
(g) a performance under pressure at a pressure of about 1.5 psi over 1 hr measured according to WO95/26209 (PUP 1.5 psi/1 hr) in the range of from about 10 to about 35 g/g, preferably from about 13 to about 30 g/g and particularly preferably from about 15 to about 27 g/g,
(h) a performance under pressure at a pressure of about 1.5 psi over 4 hr measured according to WO95/26209 (PUP 1.5 psi/4 hr) in the range of from about 20 to about 50 g/g, preferably from about 25 to about 45 g/g and particularly preferably from about 28 to about 42 g/g,
(g) a performance under pressure at a pressure of about 0.7 psi over 1 hr measured according to WO95/26209 (PUP 0.7 psi/1 hr) in the range of from about 20 to about 50 g/g, preferably from about 22 to about 45 g/g and particularly preferably from about 25 to about 40 g/g,
(h) a performance under pressure at a pressure of about 0.7 psi over 2 hr measured according to WO95/26209 (PUP 0.7 psi/2 hr) in the range of from about 25 to about 60 g/g, preferably from about 35 to about 57 g/g and particularly preferably from about 40 to about 55 g/g,
(i) a performance under pressure at a pressure of about 0.7 psi over 3 h measured according to WO95/26209 (PUP 0.7 psi/3 h) in the range of from about 30 to about 65, preferably from about 35 to about 63 and particularly preferably from about 40 to about 60 g/g,
(j) a performance under pressure at a pressure of about 0.7 psi over 4 hr measured according to WO95/26209 (PUP 0.7 psi/4 hr) in the range of from about 30 to about 70 g/g, preferably from about 35 to about 63 g/g and particularly preferably from about 40 to about 60 g/g,
(k) a saline flow conductivity measured to WO95/22356 (SFC) in the range of from about 30×10⁻⁷ to about 900×10⁻⁷ cm³×s/g, preferably of from about 50×10⁻⁷ cm³×s/g to about 700×10⁻⁷ cm³×s/g and particularly preferably of from about 70×10⁻⁷ cm³×s/g,
(l) a particle size distribution to ERT 420.1-99 (PSD) in the range of from about 10 to about 1,200 μm, preferably of about from 50 to about 900 μm and particularly preferably of from about 150 to about 850 μm.

The combinations of properties, resulting from the above properties, of two or more of these properties represent respectively preferred embodiments of the process according to the present invention. Also particularly preferred as embodiments of the invention are processes in which the composition exhibits the properties or combinations of properties shown hereinafter as letters or combinations of letters: a, b, ab, df, ef, il, abm, dfm, efm, ilm, dfhlm.

An embodiment of the process according to the present invention in which a composite is produced by bringing the composition (ZM) or the basic polymer or both into contact with a substrate in a further step is also preferred. In addition, the invention relates to a composite which may be obtained by the process according to the invention.

According to an embodiment of the process of the present invention, of the basic polymers of the present invention and of the composition of the invention it is preferred if the values of features according to the invention given only with a lower limit have an upper limit which is about 20 times, preferably about 10 times and particularly preferably about 5 times the most preferred value of the lower limit.

The present invention also relates to a composite which comprises the above-described basic polymer and the above-described composition (ZM) and a substrate, wherein the basic polymer and the composition (ZM) and the substrate are preferably securely connected to one another. Films made of polymers, such as polyethylene, polypropylene or polyamide, metals, nonwovens, fluff, tissues, wovens, natural or synthetic fibers or other foams are preferred as substrates. Sealing materials, cables, absorbent cores and diapers and sanitary articles comprising these are preferred according to the invention as composites. The sealing materials are preferably water-absorbent flat structures, preferably films, wherein the above-described basic polymer or the above-described composition is worked into a polymer matrix or fibre matrix as substrate. This preferably is carried out in that the basic polymer or the composition is mixed with a polymer (Pm) forming the polymer or fibre matrix and is subsequently connected, possibly by thermal treatment. In the event that the basic polymer or the composition is used as fibre, yarns may be obtained therefrom which are spun with further fibers consisting of a different material as substrate and are then connected to one another, for example by weaving or knitting or are directly connected, i.e. without having to be spun with further fibers. Typical processes for this purpose are described in H. Savano et al., International Wire & Cable Symposium Proceedings, 40, 333 to 338 (1991); M. Fukama et al., International Wire & Cable Symposium Proceedings, 36, 350 to 355 (1987) and in U.S. Pat. No. 4,703,132.

In the embodiment in which the composite is a cable, the basic polymer or composition (ZM) may be used directly as particles, preferably by insulating the cable. In a further embodiment of the cable the basic polymer or the composition (ZM) may be used in the form of yarns which preferably have high tenacity and are capable of swelling, and therefore making penetration of water more difficult. According to a further embodiment of the cable, the basic polymer or the composition (ZM) may be used as a swellable film. In a further embodiment of the cable again the basic polymer or the composition (ZM) may be used as a moisture-absorbing core in a cable. In the case of the cable, the substrate forms all components of the cable which do not contain a basic polymer or a composition (ZM). These include, for example, the conductors incorporated in the cable, such as electrical conductors or optical fibers, optical or electrical insulating means and components of the cable which ensure the mechanical load-bearing capacity of the cable, such as braiding, wovens or knitted fabrics made of high-tenacity materials such as plastics materials, glass fibers and insulations made of rubber or other materials which prevent destruction of the outer skin of the cable.

If the composite is an absorbent core the basic polymer or the composition (ZM) are worked into a substrate. This substrate is preferably made of fibrous materials. Fibrous materials which may be used in the present invention include naturally occurring fibers (modified or unmodified) and synthetic fibers. Examples of suitable unmodified and modified, naturally-occurring fibers include cotton, esparto grass, sugar cane, bristly wool, flax, silk, wool, cellulose, chemically modified cellulose, jute, rayon, ethyl cellulose and cellulose acetate. Suitable synthetic fibers may be produced from polyvinyl chloride, polyvinyl fluoride, polytetrafluoroethylene, polyvinylidene chloride, polyacrylate such as ORION®, polyvinyl acetate, polyethylvinyl acetate, insoluble or soluble polyvinyl alcohol, polyolefins, such as polyethylene (for example PULPEX®) and polypropylenes, polyamides, such as nylon, polyesters such as DACRON® or KODEL®, polyurethanes, polystyrenes and the like. The fibers used may include only naturally-occurring fibers, only synthetic fibers or any compatible combination of naturally-occurring and synthetic fibers.

The fibers used in the present invention may be hydrophilic or hydrophobic or they may consist of a combination of hydrophilic and hydrophobic fibers. The expression “hydrophilic”, as it is used here, describes fibers or surfaces of fibers which may be wetted by aqueous liquids (for example aqueous bodily fluids) which are deposited on these fibers. Hydrophilicity and wettability are typically defined in expressions of the contact angle and the surface tension of the liquids and solids involved. This is discussed in detail in a publication by the American Chemical Society entitled “Contact Angle, Wettability and Adhesion”, published by Robert F. Gould (Copyright 1964). A fiber or the surface of a fiber is wetted by a liquid (i.e. it is hydrophilic) if either the contact angle between the liquid and the fiber or the surface thereof is less than about 90° or if the liquid has a tendency to distribute spontaneously over the surface, both conditions normally applying at the same time. Conversely, a fiber or the surface of a fiber is deemed hydrophobic if the contact angle is greater than about 90° and the liquid does not spread spontaneously on the surface of the fiber.

According to the invention, hydrophilic fibers are the preferred fibers. Suitable hydrophilic fibers include cellulose fibers, modified cellulose fibers, rayon, polyester fibers such as polyethyeleneterephthalate (for example DACRON®), hydrophilic nylon (HYDROFIL®) and the like. Suitable hydrophilic fibers may also be obtained by hydrophilising hydrophobic fibers as with thermoplastic fibers treated with a surface-active substance or with silica and which are derived, for example, from polyolefins, such as polyethylene or polypropylene, polyacrylics, polyamides, polystyrene, polyurethanes and the like. For reasons of availability and cost, cellulose fibers, in particular pulp fibers, are preferred for use in the present invention. Further preferred hydrophilic fibers for use in the present invention are chemically reinforced cellulose fibers. The expression “chemically reinforced cellulose fibers” denotes cellulose fibers which are reinforced by chemical means, in order to increase the rigidity of the fibers under both dry and aqueous conditions. Such means may include the addition of a chemical reinforcing agent, which, for example, covers and/or impregnates the fibers. A means of this type may also include reinforcing of the fibers by changing the chemical structure, for example by crosslinking polymer chains. Polymeric reinforcing agents which may cover or impregnate the cellulose fibers include: cationic starches comprising groups containing nitrogen (for example amino groups) as may be obtained from the National Starch and Chemical Corp., Bridgewater, N.J., USA, latexes, wet-strength resins, such as polyamide epichlorohydrin resin (for example KYMENE®) 557H, Hercules, Inc., Wilmington, Del., USA), polyacrylamide resins as described, for example in U.S. Pat. No. 3,556,932, commercially obtainable polyacrylamides such as PAREZ® 631 NZ of the American Cyanamide Co., Stanfort, Conn., USA, urea formaldehydes and melamine formaldehyde resins. Fibers which have been reinforced in individual forms by crosslinking bonds (i.e. the individually reinforced fibers and the processes for their production) are described, for example, in U.S. Pat. No. 3,224,926, U.S. Pat. No. 3,440,135, U.S. Pat. No. 3,932,209 and in U.S. Pat. No. 4,035,147. Preferred crosslinking agents are glutaraldehyde, glyoxal, formaldehyde, glyoxalic acid, oxydisuccinic acid and citric acid. The reinforced cellulose fibers obtained by crosslinking or coating, impregnation or crosslinking may be twisted or crimped, the fibers preferably being twisted and additionally crimped.

In addition to the above-mentioned fibrous materials, the core may also contain thermoplastic materials. During melting at least a portion of this thermoplastic material creeps between the fibers to the intersections of the fibers, and this is typically caused by the capillary gradients. These intersections become connecting points for the thermoplastic material. When the element is cooled, the thermoplastic material solidifies at these intersections to form connecting points which hold the matrix or the woven fabric of the fibers in each of the respective layers.

The thermoplastic materials may be present in various forms, such as particles, fibers or combinations of particles and fibers. These materials may be selected from a large number of thermoplastic polymers selected from polyolefins, such as polyethylene (for example, PULPEX®) and polypropylene, polyesters, copolyesters, polyvinyl acetates, polyethylvinyl acetates, polyvinyl chlorides, polyvinylidene chlorides, polyacrylates, polyamides, copolyamides, polystyrenes, polyurethanes and copolymers of the preceding substances, such as vinyl chloride/vinyl acetate and the like. Preferably, fibrous materials consisting predominantly of cellulose are used for cores.

In a further embodiment of the core, the core comprises, in addition to the substrate and the basic polymer or the composition (ZM), further powdery substances, for example odour-binding substances such as cyclodextrins, zeolites, inorganic or organic salts and similar materials.

In one embodiment of the absorbent core, the basic polymer or the composition (ZM) are incorporated in an amount in the range of from about 10 to about 90, preferably of from about 20 to about 80 and particularly preferably of from about 40 to about 70% by weight, based on the core. In one embodiment of the core the basic polymer or the composition (ZM) is worked into the core as particles. In the process the basic polymer or the composition (ZM) may be homogeneously distributed in the fibrous materials, it may be introduced in layers between the fibrous material or the concentration of the basic polymer or of the composition (ZM) may have a gradient within the fibrous material. In another embodiment of the core, the basic polymer or the composition (ZM) are worked into the core as fibers.

A plurality of different absorbent polymers may optionally also be used simultaneously which, for example, are different in terms of suction rate, permeability, storage capacity, absorption against pressure, grain distribution or also the chemical composition. These various absorbent polymers may be introduced, in a mixed form, into the absorbent pad or else may be placed in the core so as to be locally differentiated. A differentiated placement of this kind may be made in the direction of the thickness of the core or of the length or width of the core.

The core may be combined by conventional processes known to the person skilled in the art, as generally known by the person skilled in the art, by drum-forming with the aid of shaping wheels, pockets and product forms and correspondingly adapted metering devices for the raw materials. In addition, there are modern established processes such as the so-called airlaid process (for example EP 850 615, U.S. Pat. No. 4,640,810) with all forms of metering, depositing of the fibers and consolidation such as hydrogen bonding (for example DE 197 50 890), thermobonding, latex bonding (for example EP 850 615) and hydride bonding, the so-called wetlaid process (for example WO 99/49905), carding, melt blown, spun blown processes and similar processes for producing super-absorbent nonwovens (in the sense of the definition of EDANA, Brussels) also in combinations of these processes with one another and with conventional processes for producing the core. The production of laminates in the widest sense and of extruded and coextruded, wet- and dry-strength structures and structures consolidated at a later stage are examples of further processes.

In a further embodiment of the absorbent core, the core comprises, in addition to the substrate and the basic polymer or composition (ZM) worked into the substrate, which together are used as a storage layer for the bodily fluids, an absorbent layer which is preferably used for rapid absorption and distribution of the liquid in the core. Here the absorbent layer may be arranged directly above the storage layer although it is also possible for the absorbent layer to be separated from the storage layer by a preferably liquid-stable intermediate layer. This intermediate layer is then primarily used as a support substrate for the absorbent layer and the storage layer. Preferred materials for this intermediate layer are polyester spun-bonded nonwovens or nonwovens made of polypropylene, polyethylene or nylon.

In one embodiment of the core according to the invention the absorbent layer is free of basic polymer or of the composition (ZM). The absorbent layer may be of any suitable size and does not have to extend over the entire length or width of the storage layer. The absorbent layer may, for example, be constructed in the form of a strip or patch. The entire absorbent layer is preferably hydrophilic but may also contain hydrophobic components. The absorbent layer may include a woven material, a nonwoven material or another suitable type of material. The absorbent layer is preferably based on hydrophobic polyethylene terephthalate fibers (PET fibers), chemically reinforced cellulose fibers or mixtures of these fibers. Further suitable materials are polypropylene, polyethylene, nylon or biological fibers. If the absorbent layer includes a nonwoven material it may be produced by a large number of different processes. These include wet laying, application in an air stream, application in the melt, construction as a spun-bonded nonwoven, carding (this includes thermal bonding, bonding with solvents or bonding by the melt spinning process). The last-mentioned processes (construction as a spun-bonded nonwoven and carding) are preferred if it is desired to straighten the fibers in the absorbent layer as it is easier in such processes to orientate the fibers in a single direction. A particularly preferred material for the absorbent layer is PET spun-bonded nonwoven.

In the embodiment in which the composite is a diaper, the components of the diaper, which are different from the basic polymer or the composition, are the substrate of the composite. In a preferred embodiment the diaper contains a previously described core. In this case the components of the diaper different from the core are the substrate of the composite. In general, a composite used as a diaper comprises a water-impermeable lower layer, a water-permeable, preferably hydrophobic, upper layer and a layer comprising the absorbent basic polymer or the composition, which is arranged between the lower layer and the upper layer. This layer comprising the basic polymer or the composition is preferably a previously described core. The lower layer may comprise any materials known to the person skilled in the art, polyethylene or polypropylene being preferred. The upper layer may also contain any suitable materials known to the person skilled in the art, polyester, polyolefins, viscose and the like being preferred, which result in a porous layer such that adequate liquid permeability of the upper layer is ensured. In this connection reference is made to the disclosure in U.S. Pat. No. 5,061,295, U.S. Pat. Re. 26,151, U.S. Pat. No. 3,592,194, U.S. Pat. No. 3,489,148 and U.S. Pat. No. 3,860,003.

The present invention also relates to a process for producing a composite, the basic polymer or the composition and a substrate and possibly a suitable auxiliary agent being brought into contact with one another. The components are preferably brought into contact by wetlaid and airlaid processes, compaction, extrusion and mixing. In addition, the present invention relates to a composite, which may be obtained by the above process. In addition, the present invention relates to the use of one of the basic polymers described above, preferably when it is not crosslinked, for flocculation, preferably in the treatment of water, in retention in paper production, for impurity fixing in paper production, for dry strength in paper production or for wet strength in paper production.

The present invention also relates to foams, moldings, fibers, sheets, films, cables, sealing materials, liquid-absorbing sanitary articles, supports for plant and fungicidal growth-regulating means, packaging materials and soil additives comprising the above-described basic polymer or the above-described composition and the above-described composite.

In addition, the present invention relates to the use of the above-described basic polymer or of the above-described composition or of the above-described composite foams, moldings, fibers, sheets, films, cables, sealing materials, liquid-absorbing sanitary articles, supports for plant and fungicidal growth-regulating means, packaging materials and soil additives or for controlled release of active ingredients.

The present invention will now be described in more detail by reference to non-limiting examples.

Test Methods

1. ERT

ERT stands for EDANA (European Diapers and Nonwoven Association) recommended test. These methods may be obtained from EDANA and represent a standard on which the members of EDANA have agreed.

2. Filter Test

800 ml tap water at a temperature of 20° C. was introduced into a 1,000 ml beaker. 5.00 g of the polymer sample to be investigated were dispersed, while stirring with a finger-type agitator of 3 cm at 500 rpm, in the vortex resulting from stirring so no lumps formed. The mixture was then stirred for a further 60 minutes and the resultant mixture then placed on a standard screen (125 m to DIN-ISO 3310/1-200×50 mm). After running through completely the mixture was subsequently rinsed from the beaker using 3×1 I tap water. After passage of the rinsing water, residual water located below the screen was stripped off using a rubber wiper and then the polymer located on the screen was dried to constant weight. The weight of the residue was determined from the weight of the sieve with and without residue by weighing and was related to the dry weight of the polymer.

3. Determining the Melting Point

The melting point was determined in the so-called melting point tube: The substance sample was poured into a glass tube melted off on one side, diameter approximately 1.0 to 1.5 mm, length approximately 7 to 8 cm (melting point tube, melting point capillary) to a depth of about 3 to 5 mm, according to Thile (Organikum Organisch Chemisches Grundpraktikum, 16th Edition, 1986, VEB Verlag der Wissenschaften, pages 73, 74). After introducing the substance at the top end of the tube the sample was carefully pushed downward. The filled melting point tube was then slowly heated and the temperature at which the substance sample melted determined.

### EXAMPLES

1. Preparation of Polymer and Composition

1.1 Preparation of an Aqueous Solution of the Amide Polymer

728 g demineralised water and 750 g of a 50% by weight aqueous acrylamide solution were introduced together while stirring and were rendered inert by passing nitrogen through for 60 minutes. In the process the batch was heated to a temperature of 25° C. 2.68 g 2,2′-azobisisobutyric acid nitrile dissolved in 7 g water, 1.5 g 2-mercaptoethanol and 0.9 g ascorbic acid in 7 g water were then added. 4.2 g 35% hydrogen peroxide were then added. The adiabatic polymerization reached a maximum temperature of 85° C. after 17 minutes. The polymer obtained has a molecular weight of Mp determined by gel permeation chromatography of 48,000 g/mol; Mw 56,000 g/mol and contains 70 ppm of unreacted acrylamide. The aqueous solution of the polymer has a viscosity of 1,280 m×Pas at 20° C. (Brookfield Spindle II, 10 rpm; ASTM-D 1824/90).

1.2 Preparation of an Uncrosslinked Basic Polymer

20 g of a 25% by weight aqueous polyacrylamide solution according to example 1.1 were loaded at 180° C. in the presence of 10 g of a 5% by weight ruthenium/activated carbon catalyst over a period of 6 hours with 150 bar hydrogen. The yield determined via titration of the amine groups produced with 1 normal hydrochloric acid was 51% of theoretical yield.

1.3 Preparation of a Crosslinked Basic Polymer

500 g of a 20% by weight aqueous solution of the uncrosslinked basic amine polymer from example 1.2 and 20 g maleic acid monomethylester were mixed and then heated for 16 hours to 60° C. The polymer gel obtained was comminuted using a mixer (Moulinette type D56) and dried in a drying cabinet at 70° C. and 50 mbar for 2 days. The dried polymer was then ground to a grain size to ERT 420.1-99 of 200 to 710 μm and screened.

1.4 Preparation of a Crosslinked Acid Polymer

280 g acrylic acid, 3.42 g STRATOMER® 454 (ethoxylated trimethylpropane triacrylate) and 700 g water were mixed and purged with nitrogen until the residual oxygen content was less than 0.5 ppm. 0.1 g azobisamidinopropane hydrochloride (ABAH), 0.4 g sodium persulphate, 0.05 g 35% hydrogen peroxide and 0.025 g iron sulphate with 7 g H₂O, each dissolved in 5 g water, were subsequently added one after the other while stirring. Polymerization was initiated in such a way that a temperature of 98° C. was reached after 20 minutes. After a further 60 minutes the gel block obtained was comminuted in a mincer. The polymer was then dried and ground to a grain size to ERT 420.1-99 of 200 to 710 μm and screened.

1.5 Preparation of Compositions Made of Crosslinked Basic Polymer and Crosslinked Acidic Polymer after Drying

50 g of the crosslinked basic polymer from 1.3 and 50 g of the crosslinked acidic polymer from 1.4 were mixed for 60 minutes and the data given in Tables 1 to 4 determined. A value of 255×10⁻⁷ ml×s/g was measured as SFC. The measurements were made using the methods described above.

TABLE 1

| | 0.3 | | | | |
|---|---|---|---|---|---|
| AAP | psi/1 hr | 0.3 psi/4 hr | 0.7 psi/1 hr | 0.7 psi/4 hr | 1.5 psi/4 hr |
| [g/g] | 30 | 36 | 27 | 32 | 26 |

TABLE 2

| PUP 0.7 psi | 1 h | 2 h | 3 h | 4 h |
|---|---|---|---|---|
| [g/g] | 31.5 | 46 | 49 | 53 |

TABLE 3

| PUP 1.5 psi | 1 h | 2 h | 3 h | 4 h |
|---|---|---|---|---|
| [g/g] | 19 | 26 | 30 | 34 |

TABLE 4

| AUL [psi] | 0.01 | 0.30 | 0.60 | 0.90 | 1.50 |
|---|---|---|---|---|---|
| [g/g] | 40 | 26 | 22 | 21 | 18.5 |

1.6 Preparation of Compositions of Crosslinked Basic Polymer and Crosslinked Acidic Polymer before Drying

500 g of the crosslinked basic polymer from 1.3 and 357 g acidic crosslinked polymer gel from 1.4 were combined in a mincer, comminuted and dried in a drying cabinet at 70° C. for 12 hours. The dried polymer was then ground to a grain size to ERT 420.1-99 of 200 to 710 μm and screened.

2. Preparation of an Airlaid

Airlaids were produced on an M & J airlaid unit with a ratio by weight of fibre to superabsorber (SAP) as given hereinafter in Table 5. The basic weight of the airlaid was about 250 g/m² and the thickness about 1.4 mm. The product “Fluff storer semitreated” was used as fibre, the product from Example 1.5 as superabsorber.

A test piece with a diameter of 9 cm was cut from the airlaid produced and placed according to EP 339 461 A1 on an AUL measuring table. The liquid absorption over a period of 13 hr at a load of 0.7 psi was recorded. The results ascertained by the methods described above are given in Table 5. FAVORSXM6565 is commercially available from Stockhausen GmbH.

TABLE 5

| | Fiber/ | Absorption [g/g] after | | | | |
|---|---|---|---|---|---|---|
| | SAP | 0.5 hour | 1 hour | 2 hours | 4 hours | 13 hours |
| Airlaid | 50:50 | 9.5 | 12.7 | 15.1 | 16.5 | 17.8 |
| with SAP | 30:70 | 10.0 | 14.1 | 16.5 | 18.9 | 21.0 |
| from 1.5 | | | | | | |
| Airlaid with | 50:50 | 7.5 | 10.3 | 11.4 | 11.5 | 11.8 |
| standard | 30:70 | 6.5 | 8.9 | 9.7 | 10.1 | 10.4 |
| SAP | | | | | | |
| (FAVORSXM | | | | | | |
| 6565) | | | | | | |

The airlaids produced in the preceding example were cut to a size of 30×12 cm and covered with a tissue. 3 times 60 ml 0.9% by weight NaCl solution were applied centrally under a load of 9 kg to the cut-to-size airlaid and the rewet and the liquid distribution measured over the length of the airlaid. The results are compiled in Table 6.

TABLE 6

| | | Liquid distribution | | |
|---|---|---|---|---|
| | | after addition [cm]* | | |
| Addition | Rewet [g] | 1. | 2. | 3. |
| Airlaid with 50:50 | 5 | 23 | 28 | 28 |
| (fiber/SAP) | | | | |
| SAP from 1.5 | | | | |
| Airlaid with 50:50 | 9 | 13 | 18 | 26 |
| (fiber/SAP) | | | | |
| FAVORSXM 6565 | | | | |

*Test liquid was coloured with 0.015% by weight methylene blue

1. A process for producing a basic polymer, wherein an amide polymer obtainable by chain polymerization and with at least one of the following properties:
(a) a glass transition temperature in the range of from about 30 to about 250° C.,
(b) a molar mass of at least about 1,000 g/mol,
(c) a viscosity as about 20% by weight aqueous solution of at least about 500 mPa×s,
(d) uncrosslinked
is hydrogenated.

2. The process according to claim 1, wherein hydrogenation is carried out by means of a hydrogenation catalyst.

3. The process according to claim 2, wherein the hydrogenation catalyst comprises an element of groups VI B, VII B or VIII B of the periodic table.

4. The process according to claim 2, wherein the hydrogenation catalyst comprises a support.

5. The process according to claim 1, wherein the hydrogenation is carried out according to at least one of the following parameters:
(h1) in a liquid or supercritical phase,
(h2) at a temperature of at least about 30° C.,
(h3) at a gas pressure of at least about 1 bar,
(h4) at a hydrogenating gas/inert gas ratio in the range of from about 10:1 to about 1:10.

6. The process according to claim 1, wherein the basic polymer exhibits at least one of the following properties:
(A) a glass transition temperature in the range of from about −50 to about 250° C.,
(B) a melting temperature in the range of from about −30 to about 230° C.,
(C) a molar mass of at least about 1,000 g/mol,
(D) a viscosity as about 20% by weight aqueous solution of at least about 30 mPa×s,
(E) a degree of neutralization in the range of from about 0.1 to 100%,
(F) a pH in the range of from about 5 to about 14.

7. The process according to claim 1, wherein the basic polymer is crosslinked using a cross linking agent.

8. The process according to claim, wherein the basic polymer is neutralized using a Bronsted acid.

9. A basic polymer obtainable by a process according to claim 1.

10. The process according to claim 1, wherein in a further step the basic polymer is brought into contact with a polymer which is acidic in comparison to said basic polymer, so a composition (ZM) is obtained.

11. A composition (ZM) obtainable by a process according to claim 10.

12. A composition (ZM) comprising the basic polymer according to claim 9 and a polymer which is acidic in comparison to the basic polymer.

13. The process according to claim 10, wherein in a further step a composite is produced by bringing the composition (ZM) into contact with a substrate.

14. A composite obtainable by a process according to claim 13.

15. A composite containing the basic polymer according to claim 9 and a substrate.

16. Foams, moldings, fibers, sheets, films, cables, sealing materials, liquid-absorbing sanitary articles, supports for plant and fungicidal growth-regulating means, additives for building materials, packaging materials, or soil additives comprising the basic polymer according to claim 9.

17. (canceled)

18. (canceled)

19. The basic polymer according to claim 9 used for flocculation, in retention in paper production, for impurity fixing in paper production, for dry strength in paper production or for wet strength in paper production.

20. The process according to claim 1, wherein in a further step a composite is produced by bringing the basic polymer into contact with a substrate.

21. A basic polymer obtainable by a process wherein an amide polymer obtainable by chain polymerization and at least one of the following properties:
(a) a glass transition temperature in the range of from about 30 to about 250° C.,
(b) a molar mass of at least about 1,000 g/mol,
(c) a viscosity as about 20% by weight aqueous solution of at least about 500 mPa×s,
(d) uncrosslinked
is hydrogenated.

22. The process according to claim 2, wherein the hydrogenation catalyst comprises at least two elements of groups VI B, VII B or VIII B of the periodic table.

23. A composite containing the composition according to claim 11 and a substrate.
